(19) United States
(12) Patent Application Publication
(10) Pub. No.: US 2008/0308046 A1
(43) Pub. Date: Dec. 18, 2008

(54) Deer deterring apparatus

(76) Inventor: Terry Sedivec, Granger, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 11/818,763

(22) Filed: Jun. 15, 2007

(51) Int. Cl. A01M 29/02

(52) U.S. Cl. 119/719

(57) ABSTRACT

A deer deterring apparatus is provided which deters deer from rubbing their antlers on trees, especially saplings and young trees. The apparatus is a strap with at least one sound making mechanism connected to the strap, which is loosely secured onto the trunk of a tree. When a deer approaches the tree and begins to rub its antlers against the trunk, sound making mechanism is activated. The sound startles the deer, causing it to leave the tree alone. The apparatus may also deter deer rubbing-behavior in the surrounding vicinity from where the apparatus is placed.

### BACKGROUND OF THE INVENTION

1. Field

The present invention relates to a device for deterring and/or repelling deer from rubbing their antlers on trees. In particular, the invention relates to a sound-making deterrent to frighten deer away from saplings and trees.

2. Background

In late summer and early fall, male deer often use the trunks of trees to rub the velvet off their antlers, strengthen their neck muscles in anticipation of rutting season, or mark their territory. This activity usually causes tremendous damage to saplings and young trees because bark is stripped from the tree trunk. If the stripping damage wraps all the way around the trunk, the tree will eventually die. The rubbing negatively impacts nurseries and stores that sell trees, as their inventories are damaged and depleted by the deer.

Traditionally, in an effort to prevent the damage and protect sapling and young trees from rubbing, the trunks have been wrapped with tree wrap, chicken wire, or plastic snow fencing. These prevention mechanisms have generally been inadequate. Deer become accustomed to these barriers and will rub their antlers on them, destroying both the barrier and, subsequently, the tree trunk. Other deterrent tactics include scarecrows; sonic, ultrasonic, and lighting devices triggered by motion sensors; and use of reflectors to represent a physical threat. These methods are expensive, technically complicated, require a lot of upkeep, and/or often times they simply do not work or have limited effectiveness.

Thus, a need exists for a deer deterrent/repellent which is inexpensive, simple to apply, and effective.

### SUMMARY OF THE INVENTION

An object of the present invention is to provide an apparatus for deterring deer.

A further object of the present invention is to provide an apparatus for deterring deer using a sound-making deterrent.

These and other objects of the present invention will become apparent to those skilled in the art upon reference to the following specification, drawings, and claims.

The present invention intends to overcome the difficulties encountered heretofore. To that end, an improved apparatus for deterring deer is provided. When the apparatus is attached to a tree, and a deer begins rubbing antlers on the trunk, the deer will activate the sound-making device with its antlers. The sound of the bell will startle the deer, who will then move away from the tree, thus minimizing damage to it.

### BRIEF DESCRIPTION OF THE DRAWINGS

FIG. 1 a view of a tree that has been damaged by deer rubbing.

FIG. 2 is a view of a prior art deterrent device beside the deterrent device of the present invention.

FIG. 3 is a perspective view of the present invention.

FIG. 4 is a perspective view of the present invention.

### DETAILED DESCRIPTION OF THE INVENTION

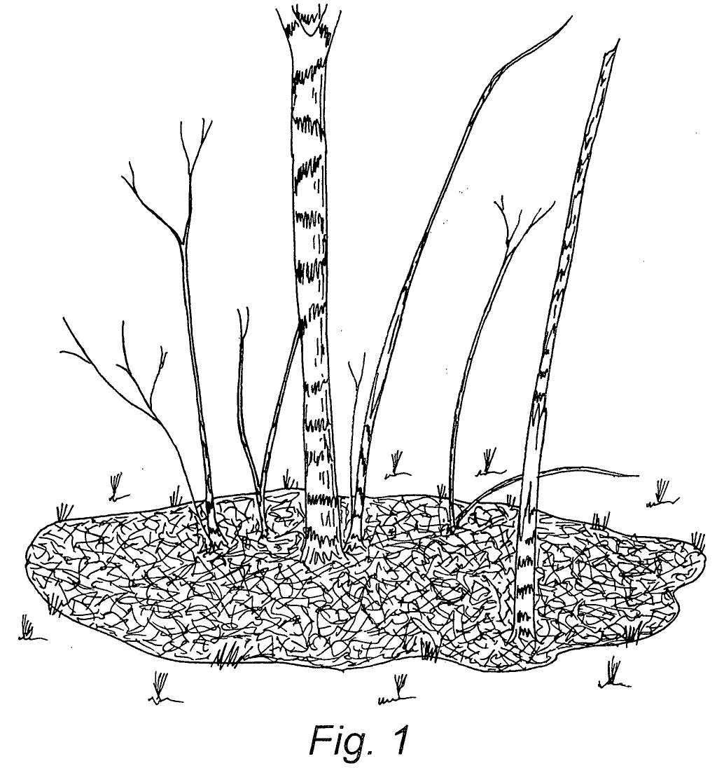

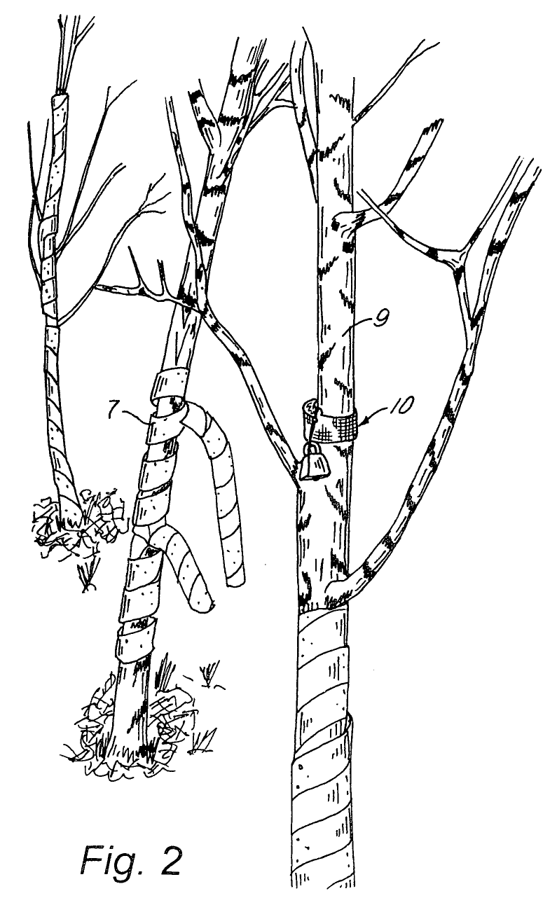

FIG. 1 shows the damage that results when deer rub their antlers on trees. The rubbing strips bark from the trees. FIG. 2 shows a prior art mechanism for protecting trees. The tree 5 has been wrapped with tape 7 in an effort to deter rubbing. As shown, the tape 7 has been rubbed off. Also in FIG. 2 is the device 10 of the present invention on a tree 9.

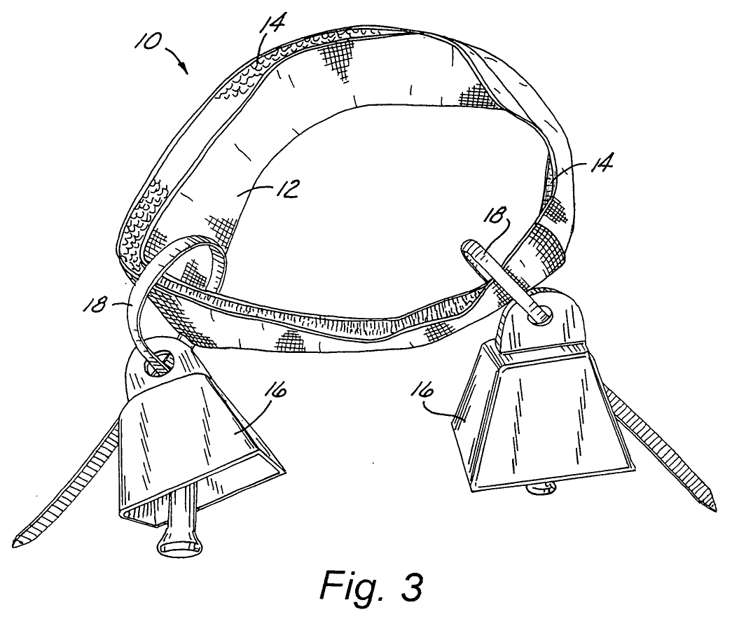

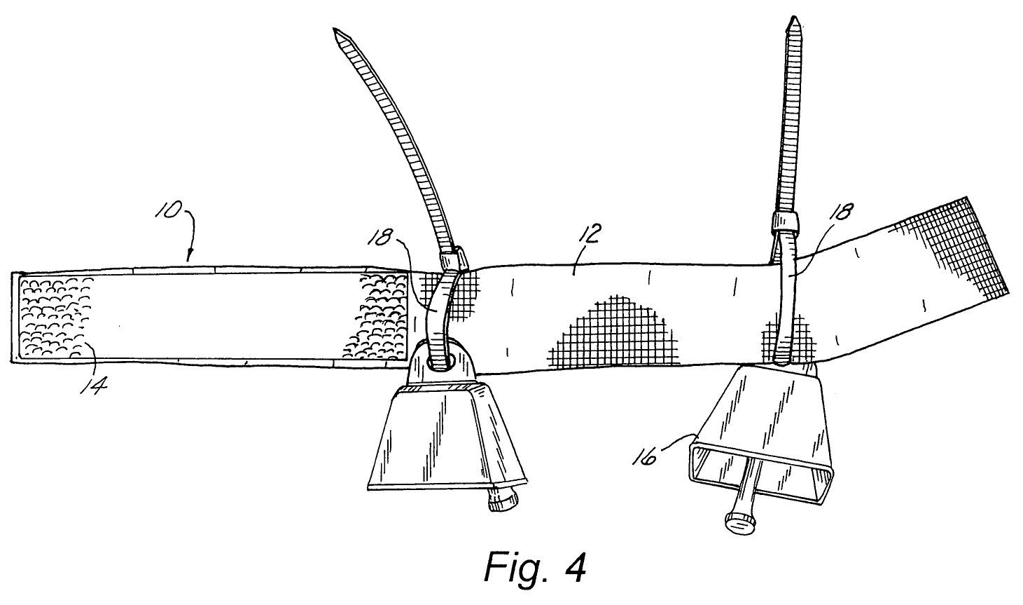

Illustrated in FIGS. 3-4 is the deer deterring apparatus 10. The device 10 generally comprises a strap member 12 for releasably securing the device 10 to the trunk of a tree. The strap member 12 includes fasteners 14, which facilitate attachment of the strap member 12 about the desired location of the tree trunk. A variety of attachment means may be used, including but not limited to Velcro, snaps, or clips. The fasteners 14 shown in the Figures are Velcro. It is also understood that the strap member 12 can be made from a variety of materials, including but not limited to vinyl, leather, cloth, canvas, or plastic.

Attached to the strap member 12 is at least one sound making member 16. In the embodiment shown in the Figures, the sound-making member is a bell. The bells 16 are generally sized between 19 mm×25 mm to 32 mm×32 mm, although other sized bells 16 would also produce the same result. The sound-making member 16 may also be a rattle, chime, or other noise-making means. As shown in FIGS. 3-4, the sound-making member 16 is connected to the strap member 12 by a connecting means 18, such as a tie, band, or loop. The connecting means 18 allows the sound-making member 16 to hang loosely from the strap member 12 and thus make sound when jostled by the animal.

The placement of the device 10 on a tree is shown in FIG. 2. The device 10 is secured in place about the tree trunk via the strap member 12 with the securing means 14. Generally, the device 10 is loosely wrapped around the trunk about where the first tree limbs branch from the tree. This placement is about three-fourths of the way up the trunk of a young tree. When the device 10 is placed at this height around a young tree, of the general size and height sold in nurseries, the deer will rub the device when it rubs the tree trunk with its antlers, thus jostling the sound means 16, which in turn frightens off the deer. It has been observed from use of the device 10 and general observation of deer behavior that the noise produced when deer rub against the tree and activates the device 10 will cause the deer to stop rubbing and to avoid the tree with the device 10, and other trees in close proximity to the tree with the device 10.

### EXAMPLE 1

A field study of the device 10 was conducted. A nursery was selected for study that was established in 2002 by the Iowa Department of Natural Resources as having a whitetail deer population in excess of 92 deer per square mile. An average heard size is usually approximately 25 per square mile. Thus, the field study was conducted in an area overpopulated with deer.

In the nursery of about 500 trees, the device 10 was placed on 100 trees that were four inches in diameter or smaller. This size tree is particularly vulnerable to being rubbed by male deer. The trees selected were in heavy traffic areas within the nursery. The trees in the nursery were observed over a three-month period. On September 17, the device 10 was installed on 100 trees. On September 24, the trees were examined. All trees with the device 10 were intact, and there were no signs of rubbing activity on any of the trees. On October 5, the trees were again examined. All of the trees with the device 10 were intact. There were signs of deer activity in the nursery, including signs of browsing. There was no rubbing on any trees at this point. On October 16, the trees were examined. All of the trees with the device 10 were intact. Heavy signs of deer activity in the nursery were observed, including fresh trails, browsing, and one tree without the device 10 had been rubbed. The rubbed tree was within twenty feet of a group of trees with the device 10. On October 30, the trees were examined. All of the trees with the device 10 were intact. Heavy signs of deer activity remained fresh. Three trees within the nursery perimeter had been rubbed, none of which had the device 10. On November 15, the trees were observed. All the trees with the device 10 were intact. A total of five trees had been rubbed within the perimeter of the nursery, none of which had the device 10 on them. Properties adjacent to the nursery were showing heavy signs of rubbing. In addition to deterring deer from rubbing trees with the device 10 on them, the device 10 changes the deer-rubbing pattern to cause them to rub outside of the nursery. Thus, the device 10 also may deter deer from rubbing on trees in close proximity to those with the device 10, even if those trees do not have the device 10 themselves.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention. For example, while the invention is intended to be used as a deer deterrent on a tree, it could also be secured to fences, telephone poles, bushes, or anywhere that deer rubbing is causing damage. In addition, while the invention is contemplated to deter deer from rubbing, it may also be used as a deterrent for other animals that engage in rubbing, including but not limited to elk, caribou, and moose.

1. An animal-deterring device for protecting trees from antler rubbing, comprising:
a) a strap member that encircles a tree trunk;
b) a fastener means for securing the strap member around the tree trunk; and
c) at least one sound-making means connected to the strap member, wherein the sound-making means is activated when an animal rubs the tree with its antlers.

2. The apparatus of claim 1, wherein the strap member is made from a weather-resistant material.

3. The apparatus of claim 1, wherein the strap member is made from leather.

4. The apparatus of claim 1, wherein the fastener means further comprises Velcro.

5. The apparatus of claim 1, wherein the sound-making means is a bell.

6. A method of deterring animals from rubbing their antlers on trees, comprising:
a) providing an apparatus having a strap member, a fastener means for securing the strap member to a tree trunk, and at least one sound-making means connected to the strap member; and
b) securing the apparatus to a tree trunk.

7. The method of claim 6, wherein the apparatus is secured to the tree trunk about where the first branches split off of the tree trunk.

8. The method of claim 6, wherein the apparatus is secured to the tree trunk approximately three-fourths of the way up the tree trunk.

9. The method of claim 6, wherein the tree is a sapling.
